(19) United States
(12) Patent Application Publication
(10) Pub. No.: US 2026/0002582 A1
(43) Pub. Date: Jan. 1, 2026

(54) CVT WITH IDLE AND REVERSE FUNCTION

(71) Applicant: Karl Zetterlund, Houston, TX (US)

(72) Inventor: Karl Zetterlund, Houston, TX (US)

(21) Appl. No.: 19/314,515

(22) Filed: Aug. 29, 2025

Related U.S. Application Data
(63) Continuation of application No. 18/445,153, filed on May 3, 2023.

(51) Int. Cl. F16H 37/12; F16H 15/08; F16H 15/40

(52) U.S. Cl. CPC F16H 37/12; F16H 15/08; F16H 15/40

(57) ABSTRACT

A continuous variable transmission variator, which works on the ball and disc principle whereby the ball is in a fixed position, free to rotate in any direction, and the discs move to and from each other causing output shaft to either idle or rotate of various speeds including reverse as directed by the attached control device, without need for additional gears and clutches.

### BACKGROUND

Not applicable.

### SUMMARY

Not applicable.

### BRIEF DESCRIPTION OF DRAWINGS

FIG. 1 is a general overview of the invention.

FIG. 2 is a general overview with parts identified by numbers.

FIG. 3 indicates gear ratios for different positions of swing arms relative to the ball.

FIG. 4 show the invention with only one swing arm.

FIG. 5A is a structural diagram showing a position where the discs center points passed each other and thus disc on swing arm B rotate faster than the disc on swing arm A.

FIGS. 5B-5F are structural diagrams showing the different respective positions and movements of the two discs.

FIG. 6 is a structural diagram showing a position where the discs are positioned further away from each other from the starting neutral point, as per FIG. 2. This will cause disc B to rotate in reverse direction as compared to i.e. FIGS. 3,4 and 5A-F.

FIG. 7 is a cross-sectional side view diagram of the presently disclosed device.

Ref. FIG. 2

### Part Specification

1 Ball
2 Rotating disc, power input
3 Rotating disc, power output
4 Shaft, power input
5 Shaft, power output
6 Gear wheel, power input
7 Gear wheel, Power output
8 Gear wheel connected to rotating disc, power input
9 Gear wheel connected to rotating disc, power output
10 Swing arm, power input
11 Swing arm, power output
12 Gear wheel for position adjustment swing arm, power input
13 Gear wheel for position adjustment swing arm, power output
14 Gear wheel for position adjustment both swing arms simultaneously
15 Gear wheels, one each side of the control wheel (14) for positioning Swing arms
16 Device for control of pressure between disc (3) and ball (1)
17 Device for control of pressure between disc (2) and ball (1)

### DETAILED DESCRIPTION

### Function:

A ball (1) is inserted in a bearing assembly where it can rotate in any direction as controlled by two rotating discs. On each side of the ball are disc (2) and (3) located. Each disc are covered with high friction material on the side touching the ball. Each disc is connected to a gear wheel (8) and (9) via a shaft and which shafts are freely rotating and also, lateral moveable via bearings in swing arms (10) and (11) in order allow for pressure adjustment for the disc against the ball.

Each swing arm can rotate on input shaft (4) and output shaft (5) respectively.

Each swing arm is provided with gear teeth connected to a positioning controlling gear (12) and (13) respectively.

Input and output shafts (4) and (5) are attached to a gear wheel (6) and (7), which are connected to gear wheel (8) and (9) respectively.

Each gear wheel (12) and (13) are connected to a speed variation common control gear (14) via gears (15) on shafts.

When control gearwheel (14) is rotated the swing arms will rotate to or from each other depending of direction of rotation whilst swing arms simultaneously changing relative position between gear wheel (9) and (7) even whilst rotating.

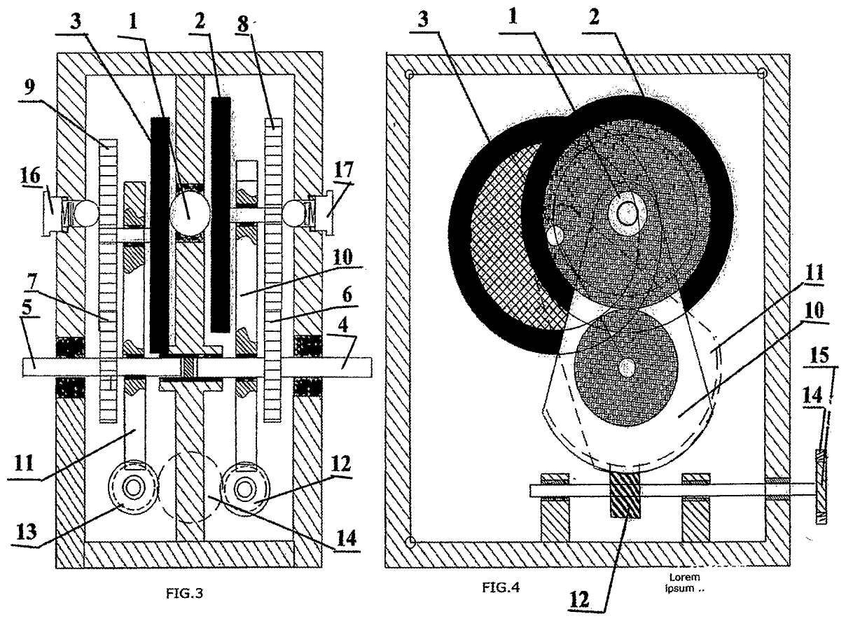

FIG. 3, indicates various speed configurations when swing arms are moving to and from each other.

### FIG. 3

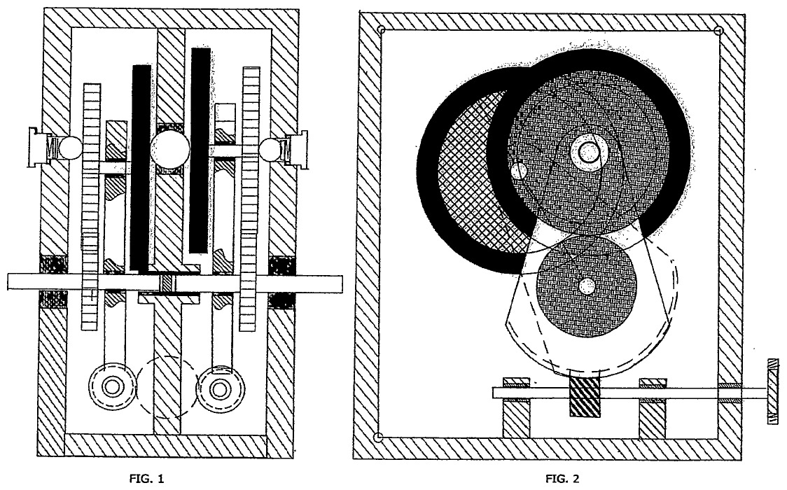

FIG. 1, indicates swing arms named A and B respectively which on following figures are only indicated as line A or B.

FIG. 2, show swing arm A with the disc in neutral position relative to the ball because the center of the disc corresponds to the center of the ball. When disc on swing arm A rotates the ball will not rotate and thus the disc on swing arm B will not rotate either.

FIG. 3, show swing arm A rotated partly to the left and thus swing arm B rotated partly to the right. The disc on swing arm A causes the ball to rotate and the disc on swing arm B to rotate in the opposite direction at a slower speed than the disc on swing arm A.

FIG. 4, show both discs in same position which will cause the discs to rotate at same speed.

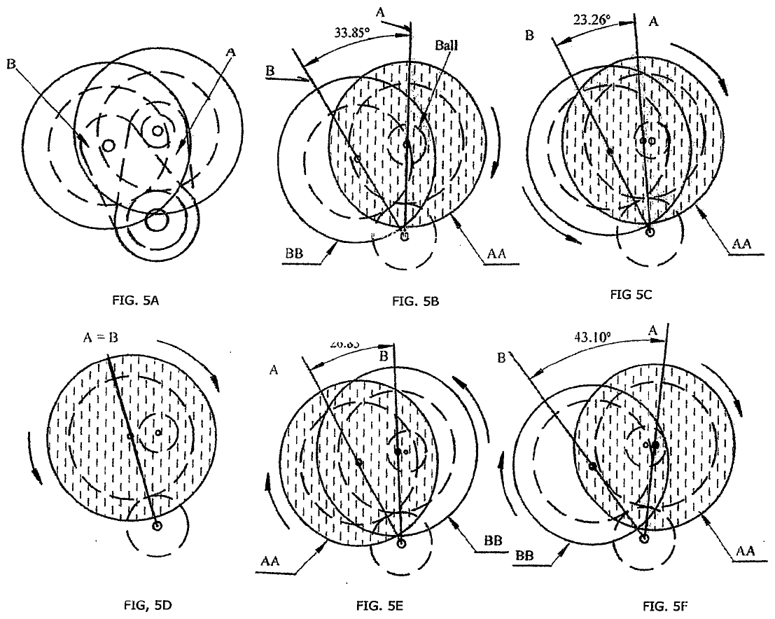

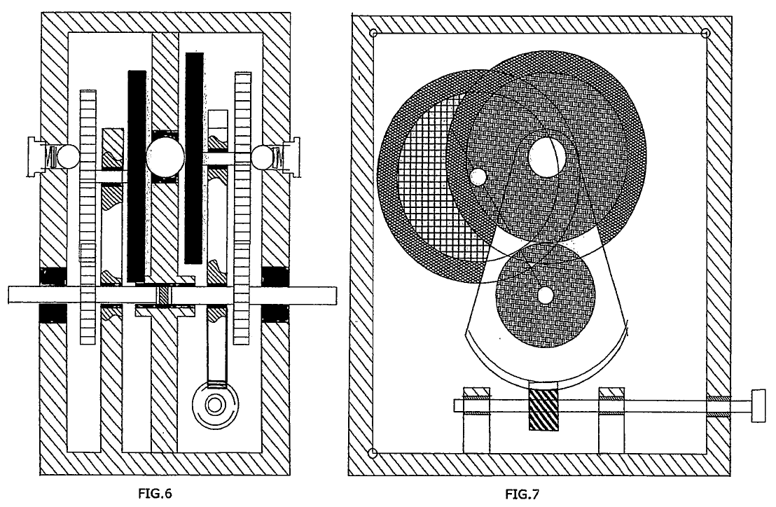

FIG. 5A, show a position where the discs center points passed each other and thus disc on swing arm B rotate faster than the disc on swing arm A.

FIGS. 5B-5F, show the different respective positions and movements of the two discs.

FIG. 6, show a position where the discs are positioned further away from each other from the starting neutral point as per FIG. 2. This will cause disc B to rotate in reverse direction as compared to i.e. FIGS. 3,4 and 5.

FIG. 7, shows a cross-sectional side view diagram of the presently disclosed device.

### FIG. 4

This drawing show the invention with only one swing arm which means that input needed of the speed variation control gear for moving the swing arm is far greater than with two swing arms moving to and from each other for achieving same result.

What is claimed is:

1. A continuous variable transmission variator, comprising:
a freely rotatable ball located between two rotatable discs, the discs being fitted on swingarms, respectively, freely rotating on an input shaft and an output shaft;
wherein the two rotatable discs fitted on the swingarms change relative positions on the input and output shafts when the swingarms move.

2. The continuous variable transmission variator of claim 1, wherein the two discs are flat, with one side of each of the two discs touching the ball.

3. The continuous variable transmission variator of claim 1, wherein the two discs are high-friction treated.

4. The continuous variable transmission variator of claim 2, wherein the two discs are treated with high-friction materials on the side of each of the two discs touching the ball.

5. The continuous variable transmission variator of claim 2, wherein when a center of a first disc of the two discs aligns with a center of the ball, a center of a second disc of the two discs is offset from a center of the ball.

6. The continuous variable transmission variator of claim 1, wherein each of the two discs is rotatably connected to one of the input or the output shaft via a first plurality of wheels and a second plurality of wheels.

7. The continuous variable transmission variator of claim 1, wherein each of the two discs rotates freely on one of the swingarms.

8. The continuous variable transmission variator of claim 1, wherein, when a center of a first disc of the two discs aligns with a center of the ball, a second disc of the two discs does not rotate.

9. The continuous variable transmission variator of claim 1, wherein, when a center of a first disc of the two discs is offset from a center of the ball, a second disc of the two discs rotates in an opposite direction with regard to the first disc.

10. The continuous variable transmission variator of claim 1, wherein each of the two swingarms includes gear teeth respectively connected to a first and second positioning controlling gears.

11. The continuous variable transmission variator of claim 10, wherein the first and second positioning controlling gears are both connected to a speed variation common control gear.

12. The continuous variable transmission variator of claim 1, wherein the swingarms are fitted with a gear track connected to a gear wheel for positioning the swingarms.

12. The continuous variable transmission variator of claim 12, wherein the swingarms are further fitted with a second gear wheel, wherein the gear wheel and the second gear wheel are positioned between the swingarms, each of the gear wheel and the second gear wheel for positioning one of the swingarms.

14. The continuous variable transmission variator of claim 12, wherein the swingarms are further fitted with a center controller gear wheel connected to both of the swingarms.

15. The continuous variable transmission variator of claim 14, wherein rotating the center controller gear causes the swingarms to move with respect to each other, thus outputting a movement from the output shaft.

16. The continuous variable transmission variator of claim 1, wherein the ball can rotate in any direction, as controlled by the two discs.

17. The continuous variable transmission variator of claim 1, wherein each of the two discs is connected to a gear wheel via a connecting shaft, wherein a movement of the connecting shaft adjusts a pressure that the disc applies to the ball.

18. The continuous variable transmission variator of claim 1, wherein the ball is fixedly located and performs no lateral movement.

19. The continuous variable transmission variator of claim 1, wherein the output shaft is configured to perform a forward, neutral, or reverse movement.

20. A method of controlling a continuous variable transmission variator, comprising:
rotating, a center controller gear wheel connected to a couple of swingarms;
wherein, the rotation of the center controller gear wheel causes the couple of swingarms to move with respect to each other, thus outputting a movement from an output shaft;
wherein the swingarms are fitted with a gear track connected to a couple of gear wheels, located on each side of the center controller gear wheel, and controlling movements of the swingarms;
wherein, the couple of swingarms are respectively connected to a couple of rotatable discs, with a fixed-positioned, freely rotatable ball located between two rotatable discs.
